(19) United States
(12) Patent Application Publication
(10) Pub. No.: US 2017/0174872 A1
(43) Pub. Date: Jun. 22, 2017

(54) AQUEOUS COMPOSITE BINDER OF NATURAL POLYMER DERIVATIVE-CONDUCTING POLYMER AND APPLICATION THEREOF

(71) Applicant: Shenzhen Xin Chang Long New Materials Technology Co, Ltd., Shenzhen (CN)

(72) Inventors: Lingzhi ZHANG, Guangzhou (CN); Dan SHAO, Guangzhou (CN); Minghao SUN, Guangzhou (CN); Haoxiang ZHONG, Guangzhou (CN); Daoping TANG, Guangzhou (CN)

(73) Assignee: Shenzhen Xin Chang Long New Materials Technology Co, Ltd., Shenzhen (CN)

(21) Appl. No.: 15/322,126

(22) PCT Filed: Sep. 4, 2013
(86) PCT No.: PCT/CN2013/082901

§ 371 Date: Dec. 26, 2016

(30) Foreign Application Priority Data
Aug. 7, 2013 (CN) 201310343220.X

(51) Int. Cl. C08L 1/28; H01M 4/62; H01M 10/0525; C08L 5/08; H01G 11/48

(52) U.S. Cl. CPC C08L 1/286; C08L 5/08; H01G 11/48; H01M 10/0525; H01M 4/624; H01M 4/622; C08L 2203/20

(57) ABSTRACT

Disclosed is an aqueous composite binder of natural polymer derivative-conducting polymer. The composite binder comprises a natural polymer derivative and a water-soluble conducting polymer at a mass ratio of 1:3.75 to 1:0.038. The composite binder can be used for a conducting electrode material and a binder material of an electrochemical energy storage device, in particular for manufacturing a lithium ion battery, a capacitor or other energy storage system. Also disclosed are a plate electrode for an enemy storage device containing the composite binder and an energy storage device containing the plate electrode.

### CROSS REFERENCE TO RELATED APPLICATIONS

This application is the national phase entry of International Application No. PCT/CN2013/082901, filed on Sep. 4, 2013, winch is, based upon and claims priority to Chinese Patent Application No. 201310343220.X, filed on Aug. 7, 2013, the entire contents of which are incorporated herein by reference.

### FIELD OF THE INVENTION

The present invention relates to the field of energy storage devices such as lithium ion batteries or supercapacitors, specifically to an aqueous composite binder of natural polymer derivative-conducting polymer and application thereof.

### BACKGROUND OF THE INVENTION

In view of the depletion of fossil fuels and the climatic deterioration, developing novel clean energy and implement of energy saving and emissions reduction have become one of the strategic directions all over the world. As the penetration of hybrid vehicles, all-electric vehicles and grid connected power plant of new energy (solar energy, wind energy) makes the high performance power (energy storage) battery one of the valued core technologies, lithium ion battery becomes the most competitive power solution for its advantages such as high voltage, high capacity, good cycling performance and low pollution; supercapacitor has also attracted enough attention in the field of novel energy storage devices, for its extremely high power density. Researches on the lithium ion battery and supercapacitor mainly focus on the active materials, electrolytes, and separators, but rarely on auxiliary materials such as conducting agents and binders. Although conducting agents and binders are used only when they are mixed with active materials or in a coating step, they are indispensible components of energy storage devices, and have a great influence to the performance of the devices.

As lithium ion and electron are both involved in the charging and discharging cycle of lithium ion battery, the electrode thereof shall be made of a material that is a good mixed conductor of both ion and electron, for higher charging and discharging current and longer cyclic life. However, commercial materials for cathode and anode are typically semiconducting, with an electronic conductivity of 10⁻¹˜10^{˜9} S/cm, which doesn't meet the requirement for the transfer of electrons in the active materials, and thus an introduction of conducting agents into the active materials is necessary to improve the conductivity. At present, most of the commercial conducting agents are carbon-based materials, such as acetylene black, carbon black, graphite, carbon nanofiber, carbon nanotube and graphene.

Binders are polymers that are used to attach the active materials to the current collector. At present, polyvinylidene fluoride is generally used in industry as a binder, with N-methyl pyrrolidone as the dispersant. Such binder with fluoride swells in electrolyte solution, which results in the decline in the adhesion; they can react with lithium to form lithium carbide, which has an influence on the life and safety of the battery; plus, they are expensive, the solvent thereof has a relative high volatilization temperature, and volatilization of the solvent will cause environmental pollution. In view of the problems, water soluble binders are gradually replacing the oil soluble binders like polyvinylidene fluoride, and become the latest commercial binders for lithium ion battery. Traditional water soluble binders include carboxymethyl cellulose (CMC), polyacrylic acid (PAA), LA132, etc. The application of alginate salts, which have higher hydroxyl content and higher cohesive strength, as binders for silicon anode materials, has been reported (Science, 7, 75-79, 2011). We have recently developed a novel water soluble binder based on chitosan and its derivatives for lithium ion battery, which exhibits good cycling stability and rate performance (Chinese patent application 201210243617). It has also been reported that, a conductive coating film consisting of conductive carbon materials and polybasic acids with hydroxyalkyl chitosan as the resin binder, was formed on a current collector to enhance the adhesion between the collector and the electrode layer, decrease the internal resistance, and also improve the cyclic characteristics (Chinese patent application 201080038127.2). This technology can achieve the desire object, but will also increase the time and cost of the production of electrodes.

Most of the commercial conductive carbon materials are nano scale or micron scale powder materials. They exhibit a bad wettability and an agglomeration tendency when applied in the aqueous binders, which probably results in an agglomeration of the particles in the dried film that affects the electronic conductivity of the electrodes, and thereby the performance of the lithium ion batteries drops so that they cannot meet the requirement.

Poly(3,4-ethylenedioxythiophene) (PEDOT), polypyrrole (PPy) and polyaniline (PAN), when they are doped, have high electronic conductivity, and have high structural and conductive stability in air. Thus, these conductive polymers have become a hot topic, and are typically used to form composites or coatings for electrode of lithium ion batteries. For example, composite electrode materials were prepared by hydrothermal synthesis from LiFePO₄ and poly(3,4-ethylenedioxythiophene) (Electroanalysis, 23, 2079-2086, 2011), and by electrochemical synthesis from LiFePO₄ and polypyrrole (J. Power Sources, 195, 5351-5359, 2010). The application of polyaniline as a binder for lithium titanium oxide, graphite and silicon/graphite composite materials has also been reported (Electrochemistry Communications 29, 45-47, 2013). Furthermore, while use of conductive binders, which are prepared by chemical synthesis from conductive polymers (such as PAN) and ionic polymers (such as PEO and PAA), for lithium ion batteries or supercapacitors, can also significantly enhance the electrochemical performance thereof, most of the ionic polymers are prepared by chemical synthesis (Chinese patent application 200610136939.6) which is high-cost and highly polluting.

### SUMMARY OF THE INVENTION

It is one object of the present invention to provide an aqueous composite binder of natural polymer derivative-conducting polymer, and an application thereof in electrochemical energy storage devices.

In aqueous binder system, commercial carbon-based conducting agents are difficult to disperse due to their low Wettability, and have low compaction density In view of the above disadvantages, conductive polymers used in, aqueous binder system as conductive additives for electrodes of lithium ion batteries and can fully or partially replace the commercial conducting agents such as acetylene black are provided. They can increase the compaction density and electric conductivity of the electrodes, and thereby the discharge capacity of the electrode materials and the cycling stability and rate performance of the batteries are enhanced. When doped with the anion of polystyrene sulfonic acid (PSS) or p-toluenesulfonic acid, the conductive polymers PEDOT, PPy and PAN can be dispersed homogeneously in aqueous solution, and have high stability, high electric conductivity and good film-forming property. Thus, doped conductive polymers (PEDOT, PPy and PAN) can filly or partially replace the commercial conducting agents such as acetylene black, and can be used in aqueous binder system as conductive additives for electrodes of lithium ion batteries to improve the electrical conductivity of the electrode materials, and somewhat overcome the disadvantages of the commercial carbon-based conducting agents such as difficulty to disperse and agglomeration tendency in aqueous binder system due to their low wettability. Also, they can form a conductive film with certain ductility on the surface of the active materials to somehow suppress the volume change of some active materials during charging and discharging. Introduction of the conductive polymers can reduce the content of commercial conducting agents such as acetylene black in electrodes to increase the compaction density of the electrodes and the volumetric specific capacity of the batteries. Moreover, they can be spread out evenly when coated on electrodes and improve the interfacial property between the electrode and the electrolyte, so as to improve the coulombic efficiency of the electrode materials, and cycling stability and rate performance of the batteries.

The aqueous composite binder of natural polymer derivative-conducting polymer contains water soluble natural polymer derivative and water soluble conductive polymer, wherein a weight ratio of the water soluble natural polymer derivative to the water soluble conductive polymer is 1:3.75˜1:0.038, and the water soluble conductive polymer contains a dopant with a Mass fraction of 67%˜71%.

The conductive polymer aqueous composite binder can be mixed with active materials and commercial conducting agents in water to form a paste that is used in the preparation of electrodes of lithium ion batteries, capacitors or other energy storage systems. The water soluble natural polymer derivative is used to increase the cohesive strength between the electrode active materials and the current collectors; the conductive polymer is water soluble, and is used to provide a homogeneous conductive connection for the active materials. The conductive polymer can partially or fully replace the commercial conducting agents such as acetylene black, and improve the electrochemical performance of batteries by reducing the internal resistance of the electrodes and increasing the compaction density thereof

The water soluble binder is at least one of the natural polymer derivatives (chitosan derivative, carboxymethyl cellulose or alginate).

The conductive polymer is that tends to be dispersed in aqueous solution or organic solution, and preferably poly(3,4-ethylenedioxythiophene), polyaniline or polypyrrole. The dopant in the conductive polymer is a poly(styrenesulfonate) salt or a p-toluenesulfonate salt. The doped conductive polymer can fully or partially replace the commercial conducting agents in aqueous binder system, wherein the commercial conducting agents are acetylene black, carbon black, ketjen black, natural graphite, synthetic graphite, carbon nanofiber, carbon nanotube and graphene. The mass faction of the conductive polymer in the conducting agent is 1%˜100%.

The binder of the present invention can be combined with dispersion medium, which is an aqueous solution of a dispersant such as polystyrene sulfonic acid (PSS). The mass fraction of the conductive polymer (PEDOT, PAN or PPy) in the dispersion medium is 1:100˜1:10; the solid content of the PEDOT:PSS solution is 1%˜3%, the solid content of the PAN:PSS solution is 1%˜10%, and the solid content of the PPy:PSS solution is 1%˜10%.

The resent invention can be applied to at least one of the following active materials: lithium iron phosphate, lithium cobalt oxide, lithium manganese oxide, nickel-cobalt-manganese ternary material, lithium nickel manganese oxide, lithium nickel phosphate, lithium cobalt phosphate, lithium manganese phosphate, lithium-rich solid solution cathode material, graphite, lithium, titanium oxide, metal oxide anode material, tin-based composite anode material and silicon-based composite anode material.

Use of the aqueous composite binder of natural polymer derivative-conducting polymer as electrode conducting material and binder material of electrochemical energy storage devices is also provided, which is capable of hilly or partially replacing the commercial conducting agent, and can be applied in the production of lithium ion batteries, capacitors or other energy storage systems. The conductive polymer aqueous composite binder can be used to produce an electrode plate for energy storage devices, electrode material of which contains the aforementioned aqueous composite binder of natural polymer derivative-conducting polymer. According to another aspect of the invention, an energy storage device having the aforementioned electrode plate includes but is not limited to lithium ion battery and supercapacitor.

Compared with the prior art, the present invention provides the following advantages:

(1) The water soluble polymer derivatives used therein is natural, low-cost and pollution-free, and can be obtained widely.

(2) Doped conductive polymers (PEDOT, PPy Or PAN) are used as conducting agent in aqueous binder system. These polymers can be dispersed homogeneously in aqueous solution, have high stability, and can form a film with high electrical conductivity over the surface of active materials so as to improve the electrical conductivity of the materials. Meanwhile, the film has good ductility so that it can somehow suppress the volume change of some active materials (for example, silicon-based anode material) during charging and discharging, so as to improve the rate performance of the batteries and increase the life thereof.

(3) Commercial carbon-based conductive materials tend to agglomerate and are difficult to be dispersed in aqueous system due to their low wettability. This disadvantage is somehow overcome by partially replacing them with doped conductive polymers (PEDOT, PPy or PAN).

(4) The content of commercial conducting agents such as acetylene black in the electrode is reduced by introduction of the conductive polymer, resulting in that, the compaction density of the electrodes and the volumetric specific capacity of the batteries increase, and internal resistance of the electrodes is reduced such that the rate performance of the batteries is enhanced.

(5) The binder of the present invention can be spread out evenly when coated on electrode and improve the interfacial property between electrode and electrolyte, so as to improve coulombic efficiency of the electrode materials and cycling stability and rate performance of the batteries.

(6) The water soluble natural polymer derivative binder containing conductive polymer of the present invention can be applied to both anode materials and cathode materials.

(7) The present invention is environmental friendly, easy to implement with its simple and reproducible preparation, widely applicable, and thus provides a research direction for high capacity lithium ion batteries.

### BRIEF DESCRIPTION OF THE DRAWINGS

FIG. 1 shows SEM images of the conducting agents used in embodiment 1 and silicon (elementary substance) electrode plates made thereof, wherein: (a) SEM image of acetylene black, (b) SEM image of PEDOT/PSS (c) SEM image (at low magnification) of a electrode plate without PEDOT/PSS, (d) SEM image (at high magnification) of a electrode plate without PEDOT/PSS, (e) SEM image (at low magnification) of a electrode plate with PEDOT/PSS, (f) SEM image (at high magnification) of a electrode plate with PEDOT/PSS, (g) SEM image of a electrode plate without PEDOT/PSS, having been subject to 100 cycles, and (h) SEM image of a electrode plate with PEDOT/PSS, having been subject to 100 cycles.

FIG. 2 shows the AC impedance curves of silicon (elementary substance) electrode plates with different amount of PEDOT/PSS its embodiment 1.

FIG. 3 shows the charge/discharge curves of the first cycle of silicon (elementary substance) electrode plates with different amount of PEDOT/PSS in embodiment 1, at 0.01˜1.50V under 200 mA/g.

FIG. 4 shows the cyclic voltammograms of the first three cycles of silicon (elementary substance) electrode plates with 50% (mass fraction) of PEDOT/PSS in the whole conducting agent and without PEDOT/PSS in embodiment 1 at a scan rate of 0.2 mV/s.

FIG. 5 shows the electrochemical cycling curves of silicon (elementary substance) electrode plates with different amount of PEDOT/PSS in embodiment 1, at 0.01˜1.50V under 200 mA/g.

FIG. 6 shows the electrochemical rate cycling curves of silicon (elementary substance) electrode plate with 50% (mass fraction) of PEDOT/PSS in the whole conducting agent in embodiment 1, at 0.01˜1.50V under 200˜10000 mA/g.

FIG. 7 shows the charge/discharge curves of the first cycle of silicon (elementary substance) electrode plate in embodiment 2 with 33% (mass fraction) of PEDOT/PSS in the whole conducting agent, carboxymethyl chitosan as the binder, at 0.01˜1.50V under 200 mA/g.

FIG. 8 shows the charge/discharge curves of the first cycle of silicon (elementary substance) electrode plates with different amount of PAN/PSS in embodiment 3, at 0.01˜1.50V under 200 mA/g.

FIG. 9 shows the electrochemical cycling curves of silicon (elementary substance) electrode plates with different amount of PAN/PSS in embodiment 3, at 0.01˜1.50V under 200 mA/g.

FIG. 10 shows the AC impedance curves of silicon (elementary substance) electrode plates with different amount of PAN/PSS in embodiment 3.

FIG. 11 shows the charge/discharge curves of the first cycle of silicon (elementary substance) electrode plate with 50% (mass fraction) of PPy/PSS and without PPy/PSS in embodiment 4, at 0.01˜1.50V under 200 mA/g.

FIG. 12 shows the electrochemical cycling curves of silicon (elementary substance) electrode plates with 50% (mass fraction) of PPy/PSS and without PPy/PSS in embodiment 4, at 0.01˜1.50V under 200 mA/g.

FIG. 13 shows the electrochemical cycling curves of graphite electrode plates with 50% (mass fraction) of PEDOT/PSS in the whole conducting agent in embodiment 5, at 0.00˜3.0V under 100 mA/g.

FIG. 14 shows the electrochemical rate cycling curves of graphite electrode plate with 50% (mass fraction) of PEDOT/PSS in the whole conducting agent in embodiment 5, at 0.00˜3.0V under 100˜2000 mA/g.

FIG. 15 shows the AC impedance curves of graphite electrode plate in embodiment 6 with 33% (mass fraction) of PEDOT/PSS in the whole conducting agent, carboxymethyl chitosan as the binder.

FIG. 16 shows the electrochemical cycling curves of lithium titanium oxide electrode plates in embodiment 7 with 50% (mass fraction) of PEDOT/PSS and without PEDOT/PSS, CMC as the binder, at 1.0˜2.5V under 0.5˜5 C.

FIG. 17 shows the electrochemical rate curves of lithium titanium oxide electrode plates in embodiment 7 with 50% (mass fraction) of PEDOT/PSS and without PEDOT/PSS, CMC as the binder, at 1.0˜2.5V under 0.5˜5 C.

FIG. 18 shows the cycling curves of LFP cathode material in embodiment 8 wherein 50% of acetylene black is replaced with conductive polymer PEDOT/PSS iu a water soluble chitosan binder.

FIG. 19 shows the cycling curves of LFP cathode material in embodiment 9 wherein 30% of acetylene black is replaced with conductive polymer PEDOT/PSS, in a water soluble chitosan binder.

FIG. 20 shows the AC impedance curves of LFP cathode material in embodiment 9 wherein 30% of acetylene black is replaced with conductive polymer PEDOT/PSS, in a water soluble chitosan binder.

FIG. 21 shows the cycling curves of LFP cathode material in embodiment 10 wherein 1% of acetylene black is replaced with conductiNre polymer PEDOT/PSS, in a water soluble chitosan binder.

FIG. 22 shows the cycling curves of LFP cathode material in embodiment 11 wherein 100% of acetylene black is replaced with conductive polymer PEDOT/PSS, in a water soluble chitosan binder.

FIG. 23 shows the cycling curves of LFP cathode material in embodiment 13 wherein 10% of acetylene black is replaced with conductive polymer PEDOT/PSS, in a water soluble sodium alginate binder.

FIG. 24 shows the cycling curves of ternary cathode material in embodiment 14 wherein 10% of acetylene black is replaced with conductive polymer PEDOT/PSS, in a water soluble chitosan binder (4% of chitosan aqueous solution, 2% of SBR aqueous solution and 2% of PEO aqueous solution as the binder).

FIG. 25 shows the AC impedance curves of LCO cathode material in embodiment 15 wherein 10% of acetylene black is replaced with conductive polymer PEDOT/PSS, in a water soluble chitosan binder.

### DETAILED DESCRIPTION OF THE INVENTION

Further characteristics and advantages of the present invention will be more readily apparent from the detailed description of the following embodiments.

### Embodiment 1

Acetylene black was partially replaced with conductive polymer PEDOT/PSS in a CMC aqueous binder for silicon-based anode material, which comprised the following steps:

Preparation of electrode plates: Each plate comprised of, in mass percentage, 70% of silicon (elementary substance) powder as an anode active material, 10% of CMC aqueous solution (with a viscosity of 300˜1200 cps) as a binder, and 20% of conducting agent. In different sample, the mass fraction of PEDOT/PSS in the whole conducting agent (a commercial product of Sigma Aldrich, and mass fraction of the dopant in conductive polymer was 71%) was 20%, 33% or 50%, and mass ratio of CMC and PEDOT/PSS was 1:0.4, 1:0.66 or 1:1. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200˜10000 mA/g.

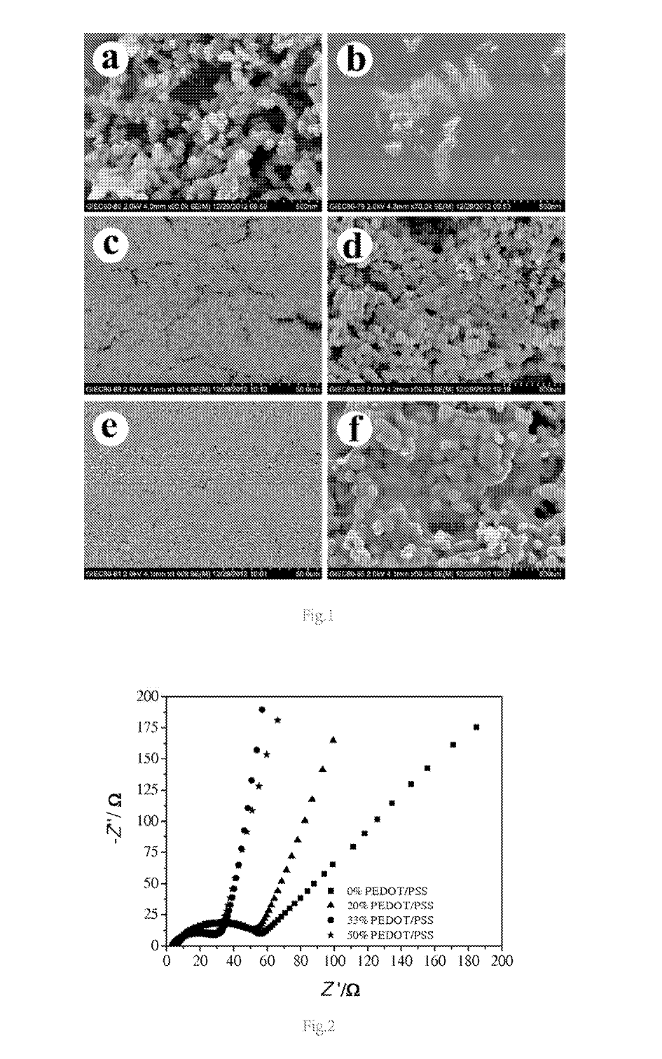

Test results: As shown in FIG. 1a and 1b, acetylene black was in the form of particles of about 50 nm, while PEDOT/PSS was in the form of sheets or membranes. As shown in FIGS. 1c and 1e, uniformity of the silicon-based anode plate was improved when the acetylene black therein was replaced with the conductive polymer PEDOT/PSS. As shown in FIGS. 1d and 1f, the conductive polymer PEDOT/PSS had formed a compact conductive film over the surface of the active material. As shown in FIGS. 1g and 1h, the conductive polymer PEDOT/PSS had formed a compact conductive film over the surface of the active material.

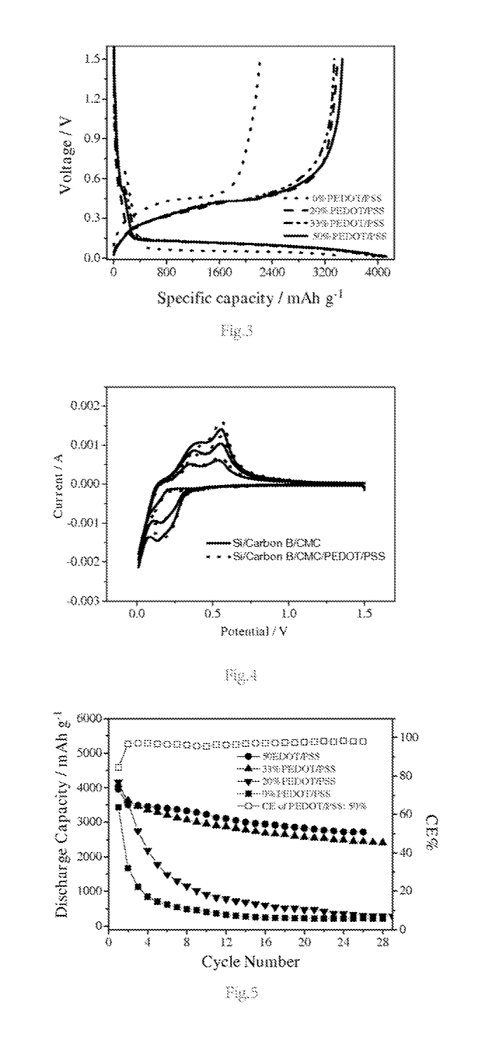

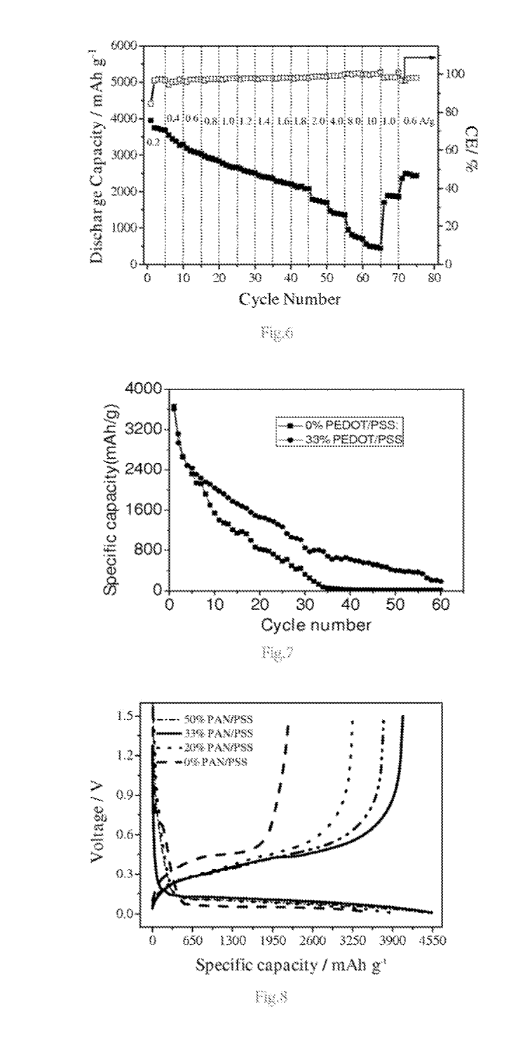

As shown in FIG. 2, introduction of the conductive polymer can effectively reduce the charge transfer impedance of the electrode material. As shown in FIG. 3, under 200 mA/g, the silicon (elementary substance) material with only acetylene black showed a first specific discharge capacity of 3422 mAh/g and a first coulombic efficiency of 66%, while that in which acetylene black was partially replaced with PEDOT/PSS showed a first specific discharge capacity of 3954˜4163 mAh/g and a first coulombic efficiency of 81˜85%. Plus, introduction of PEDOT/PSS had efficiently reduced the voltage difference of the charge/discharge plateau, indicating that the polarization of the electrode daring charging/discharging was reduced. The voltammograms (as shown in FIG. 4) of the first three cycles of the electrodes also indicated that introduction of PEDOT/PSS significantly reduced the polarization of the electrode in the first three cycles. The specific discharge capacity of the silicon (elementary substance) electrode with 50% (mass fraction) of PEDOT/PSS in the whole conducting agent after 27 cycles was around 3000, much higher that that with only acetylene black (as shown in FIG. 5), and maintained a specific discharge capacity of 2440 mAh/g under 600 mA/g after cycling under a sequence of current density ranged from 200˜10000 mA/g with 5 cycles each (as shown in FIG. 6).

### Embodiment 2

Acetylene black was partially replaced with conductive polymer PEDOT/PSS in a carboxymethyl chitosan aqueous binder for silicon-based anode material, which comprised the following steps:

Preparation of electrode plates: Each plate comprised of, in mass percentage, 70% of silicon (elementary substance) powder as an anode active material, 10% of carboxymethyl chitosan aqueous solution (with a viscosity of 100˜200 cps as a binder, and 20% of conducting agent. The mass fraction of PEDOT/PSS in the whole conducting agent (a commercial product of Sigma Aldrich, and mass fraction of the dopant in conductive polymer was 71%) was 33%, and mass ratio of carboxymethyl chitosan and PEDOT/PSS was 1:0.66. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200˜10000 mA/g.

Test results: As shown in FIG. 7, when using carboxymethyl chitosan aqueous solution as the binder, the silicon (elementary substance) material with only acetylene black as the conducting agent showed a tint specific discharge capacity of 3658 mAh/g; when the content of PEDOT/PSS in the whole conducting agent was 33% (mass fraction), it showed a first specific discharge capacity of 3750 mAh/g, and the cycling stability of the battery increased significantly,

### Embodiment 3

Acetylene black was partially replaced with conductive polymer PAN/PSS in a CMC aqueous binder for silicon-based anode material, which comprised the following steps:

Preparation of electrode plates: Each plate comprised of, in mass percentage, 70% of silicon (elementary substance) powder as an anode active material, 10% of CMC aqueous solution (with a viscosity of 300˜1200 cps) as a binder, and 20% of conducting agent. In different sample, the mass fraction of PAN/PSS in the whole conducting agent (a commercial product of Sigma Aldrich, and mass fraction of the dopant in conductive polymer was 67%) was 20%, 33% or 50%, and mass ratio of CMC and PAN/PSS was 1:0.4, 1:0.66 or 1:1. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate. The PAN/PSS aqueous solution was prepared in the laboratory with a solid content of 2.14% with reference to J. Mater Sci. 41(2006), 7604-7610), wherein the organic solution of PAN was a commercial product of Aldrich (a toluene solution with a solid content of 2˜3%).

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200 mA/g.

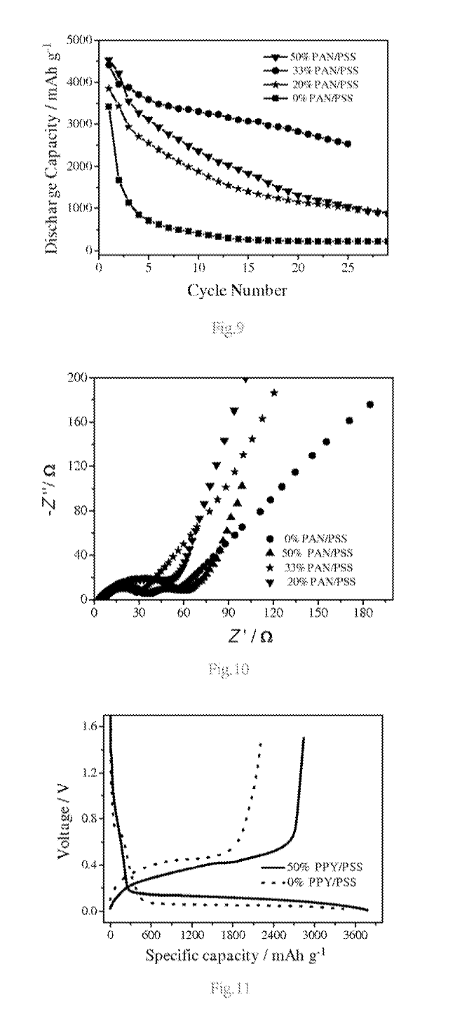

Test results: As shown in FIG. 8, under 200 mA/g the silicon (elementary substance) material with only acetylene black showed a first specific discharge capacity of 3422 mAh/g and a first coulombic efficiency of 66%, while that in which acetylene black was partially replaced with PAN/PSS showed a first specific discharge capacity of 3855˜4533 mAh/g and a first coulombic efficiency of 84˜90%. Plus, introduction of PAN/PSS had efficiently reduced the voltage difference of the charge/discharge plateau, indicating that the polarization of the electrode during charging/discharging was reduced. The specific discharge capacity of the silicon (elementary substance) electrode with 33% (mass fraction) of PAN/PSS in the whole conducting agent after 25 cycles was around 2500, much higher that that with only acetylene black (as shown in FIG. 9). As shown in FIG. 10, introduction of the conductive polymer PAN can effectively reduce the charge transfer impedance of the electrode material.

### Embodiment 4

Acetylene black was partially replaced with conductive polymer PPy/PSS in a CMC aqueous binder for silicon-based anode material, which comprised the following steps:

Preparation of electrode plates: Each plate comprised of, in mass percentage, 70% of silicon (elementary substance) powder as an anode active material, 10% of CMC aqueous solution (with a viscosity of 300-1200 cps) as a binder, and 20% of conducting agent. The mass fraction of PPy/PSS in the whole conducting agent (a commercial product of Sigma Aldrich, and mass fraction of the dopant in conductive polymer was 67%) was 50%, and mass ratio of CMC and PPWPSS was 1:1. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate. The PPy/PSS aqueous solution was prepared in the laboratory with a solid content of 2.06% (with reference to J. Mater. Sci. 41(2006), 7604-7610).

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200 mA/g.

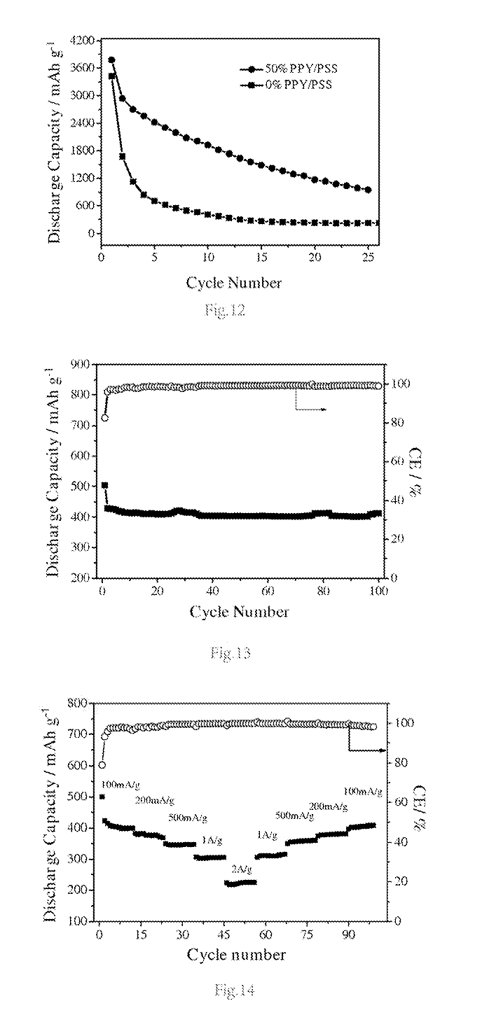

Test results: As shown in FIG. 11, under 200 mA/g, the silicon (elementary substance) material with only acetylene black showed a first specific discharge capacity of 3422 mAh/g and a first coulombic efficiency of 66%, while that in which acetylene black was partially replaced with PPy/PSS showed a first specific discharge capacity of 3775 mAh/g and a first coulombic efficiency of 75%. Plus, introduction of PPy/PSS had efficiently reduced the voltage difference of the charge/discharge plateau, indicating that the polarization of the electrode during charging/discharging was reduced. The specific discharge capacity of the silicon (elementary substance) electrode with 50% (mass fraction) of PPy/PSS in the whole conducting agent after 25 cycles was around 953 mA/h (as shown in FIG. 12).

### Embodiment 5

Acetylene black was partially replaced with conductive polymer PEDOT/PSS in a CMC aqueous binder for graphite anode material, which comprised the following steps:

Preparation of electrode plates: Each plate comprised of, in mass percentage, 80% of commercial graphite as an anode active material, 10% of CMC aqueous solution (with a viscosity of 300˜1200 cps) as a binder, and 10% of conducting agent. The mass fraction of PEDOT/PSS in the whole conducting agent (a commercial product of Sigma Aldrich, and mass fraction of the dopant in conductive polymer was 71%) was 50%, and mass ratio of carboxymethyl chitosan and PEDOT/PSS was 1:0.5. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.0˜3.0V under 100˜2000 mA/g.

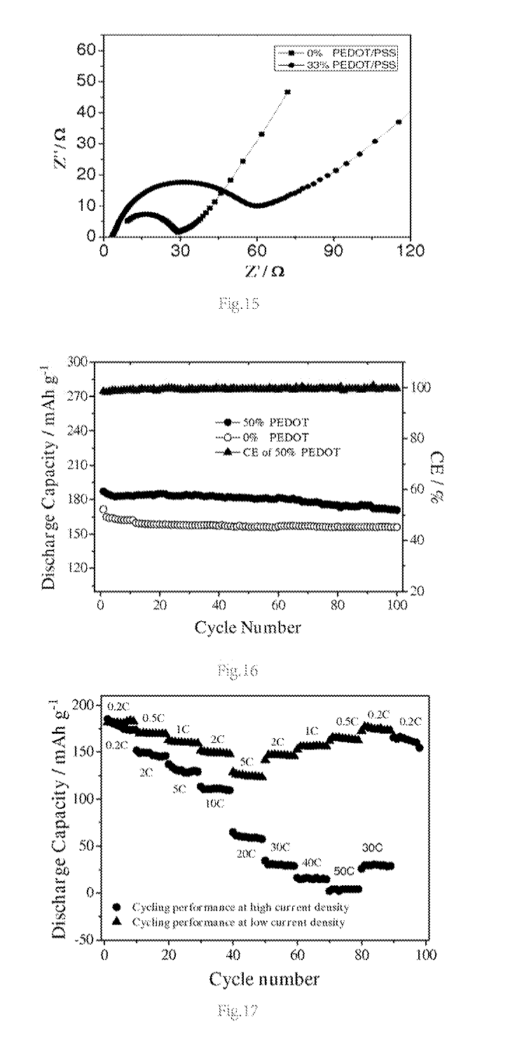

Test results: As shown in FIG. 13, the graphite electrode with 50% (mass fraction) of PEDOT/PSS in the whole conducting agent showed a first specific discharge capacity of 509 mAh/g and a first coulombic efficiency of 82%, and maintained a specific discharge capacity of around 413 mAh/g after 100 cycles, which is much higher than the theoretical value of graphite. It maintained a specific discharge capacity of 405 mAh/g under 100 mA/g after cycling under a sequence of current density ranged from 100˜2000 mA/g with 10 cycles each (as shown in FIG. 14).

### Embodiment 6

Acetylene black was partially replaced with conductive polymer PEDOT/PSS in a carboxymethyl chitosan (CTS) aqueous binder for graphite anode material, which comprised the following steps:

Preparation of electrode plates: Each plate comprised of, in mass percentage, 80% of commercial graphite as an anode active material, 10% of CTS aqueous solution (with a viscosity of 100˜200 cps) as a binder, and 10% of conducting agent. The mass fraction of PEDOT/PSS in the whole conducting agent (a commercial product of Sigma Aldrich, and mass fraction of the dopant in conductive polymer was 71%) was 33%, and mass ratio of CTS and PEDOT/PSS was 1:0.3. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.0˜3.0V under 100˜2000 mA/g.

Test results: As shown in FIG. 15, the impedance of the battery was reduced from 60 Ω/cm² (without PEDOT/PSS) to 30 Ω/cm² (with 33% (mass fraction) of PEDOT/PSS in the whole conducting agent).

### Embodiment 7

Acetylene black was partially replaced with conductive polymer PEDOT/PSS in a CMC aqueous binder for lithium titanium oxide anode material, which comprised the following steps:

Preparation of electrode plates: Each plate comprised of, in mass percentage, 80% of lithium titanium oxide as an anode active material, 10% of CMC aqueous solution (with a viscosity of 300˜1200 cps) as a binder, and 10% of conducting agent. The mass fraction of PEDOT/PSS in the whole conducting agent (a commercial product of Sigma Aldrich, and mass fraction of the dopant in conductive polymer was 71%) was 50%, and mass ratio of CMC and PEDOT/PSS was 1:0.5. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.5˜3.0V and 0.2˜50 C

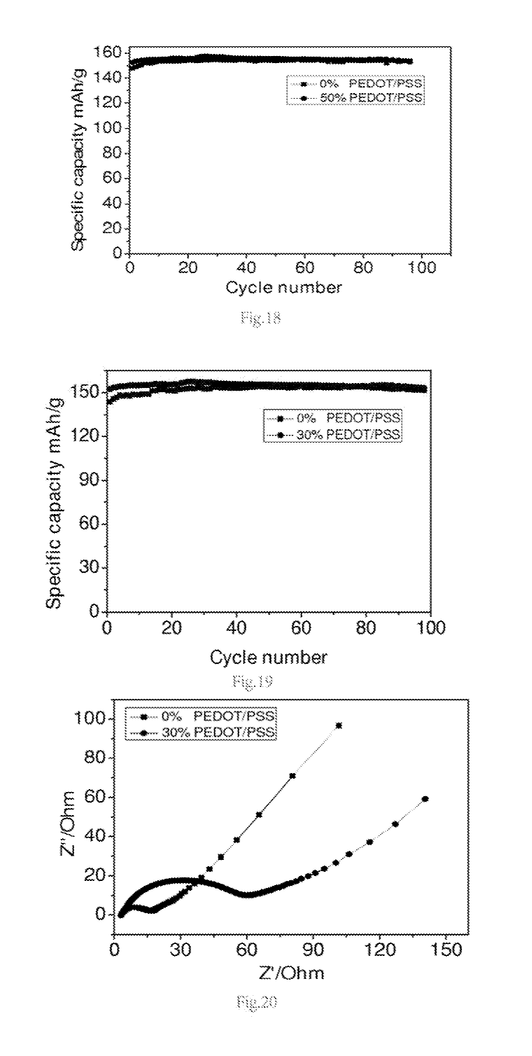

Test result: As shown in FIG. 16, at a rate of 0.5 C, while the lithium titanium oxide anode with acetylene black only as conducting agent showed a first specific discharge capacity of 171 mAh/g, and maintained a specific discharge capacity of around 156 mAh/g after 100 cycles, the lithium titanium oxide anode with 50% (mass fraction) of PEDOT/PSS in the whole conducting agent showed a first specific discharge capacity of 187 mAh/g and a first coulombic efficiency of 98%, and maintained a specific discharge capacity of around 171 mAh/g after 100 cycles, which is close to the theoretical value of lithium titanium oxide. At a rate of 0.2 C, it maintained a specific discharge capacity of 173 mAh/g after cycling from 0.2 to 0.5 C, and 161 mAh/g after cycling from 0.2˜50 C (as shown in FIG. 17).

### Embodiment 8

50% of acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 50%, and mass ratio of CTS and PEDOT/PSS was 1:1.88. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 18, at 0.1 C, the LFP electrode wherein 50% of the commercial conducting agent was replaced with PEDOT/PSS showed a first specific discharge capacity of 144 mAh/g and a first coulombic efficiency of 91.74%. The specific discharge capacity increased from the second cycle on, and remained at around 154 mAh/g after 100 cycles, indicating a capacity retention close to 100%.

### Embodiment 9

30% of acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 30%, and mass ratio of CTS and PEDOT/PSS was 1:1.13. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.5˜4.0V under 100˜2000 mAh/g.

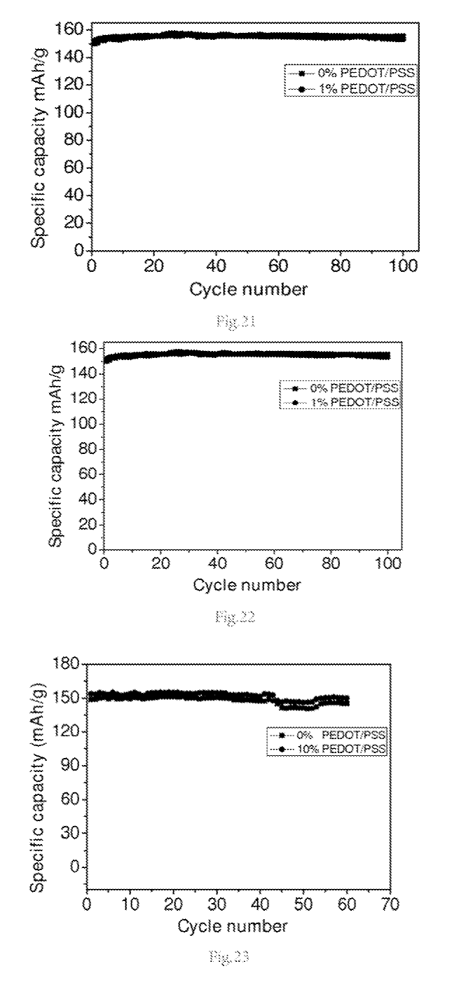

Test results: As shown in FIG. 19, capacity of the commercial LFP electrode wherein 30% of acetylene black was replaced with PEDOT/PSS increased significantly during the first few cycles, and reached and stabilized at about 150 mAh/g, which remained at 152 mA/h after 100 cycles. As shown in FIG. 20, the impedance of the battery was reduced from 60 Ω/cm² (without PEDOT/PSS) to 1.5 Ω/cm² (with PEDOT/PSS).

### Embodiment 10

1% of acetylene black in a chitosan aqueous binder for LFP cathode material was replaced with conductive polymer PEDOT/PSS, which comprised the following steps:

Preparation of electrode plates: Each plate comprised of, in mass percentage. 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 1%, and mass ratio of CTS-based binder and PEDOPPSS was 1:0.038. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 21, the commercial LFP electrode wherein 1% of acetylene black was replaced with PEDOT/PSS had a first specific discharge capacity of 145 mAh/g at 0.1 C. The specific discharge capacity thereof increased during the first few cycles, and maintained at about 153 mAh/g after 100 cycles, indicating a capacity retention close to 100%.

### Embodiment 11

All the acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent The mass fraction of PEDOT/PSS in the whole conducting agent (a commercial product of Sigma Aldrich, and mass fraction of the dopant in conductive polymer was 71%) was 100%, and mass ratio of CTS and PEDOT/PSS was 1:3.75. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 22, the commercial LFP electrode wherein all the acetylene black was replaced with PEDOT/PSS had a first specific discharge capacity of 138 mAh/g at 0.1 C. The specific discharge capacity thereof increased from the second cycle on, and reached and maintained at about 147.6 mAh/g after 100 cycles.

### Embodiment 12

Determination of the compaction density of LFP cathode material, wherein all the acetylene black in a chitosan aqueous binder for LFP cathode material was replaced with conductive polymer PEDOT/PSS.

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 100%, and mass ratio of CTS and PEDOT/PSS was 1:3.75. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate with a certain surface density.

With regard to design of lithium ion battery, compaction density=surface density/thickness of the material=surface density/(thickness of the rolled plate−thickness of the current collector), and the unit of compaction density is g/cm³. The above-mentioned plate with a known surface density was rolled under a certain pressure to a certain thickness which was then measured to calculate the compact density. Under laboratory condition, the compact density of the plate without PEDOT/PSS is 1.4 g/cm³, while that with PEDOT/PSS is 1.7 g/cm³, indicating that introduction of PEDOT/PSS can significantly increase the compaction density of electrode plate.

### Embodiment 13

The acetylene black in a sodium alginate aqueous binder for LFP cathode material was partially replaced with conductive polymer PEDOT/PSS, which comprised the following steps:

Preparation of electrode plates: Each plate comprised of, in mass percentage, 90% of commercial LFP as a cathode active material, 1.6% of sodium alginate aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 10%, and mass ratio of sodium alginate and PEDOT/PSS was 1:0.375. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as confer electrode, polyethylene membrane as separator, and a mixture of 1M LiPF₆/EC, DEC and DMC (1:1:1 in volume ratio) as electrolyte solution. A galvanostatic charge and discharge test on the batteries was performed at 3.0˜4.2V under 100˜2000 mAh/g.

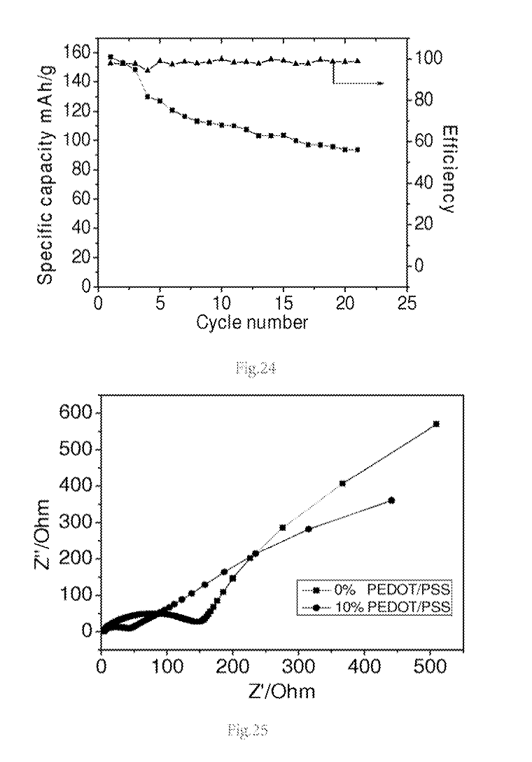

Test results: As shown in FIG. 23, LFP cathode material with sodium alginate as the binder wherein 10% of acetylene black was replaced with PEDOT/PSS could maintain a good cycling performance and high specific capacity.

### Embodiment 14

The acetylene black in a carboxylated chitosan aqueous binder for ternary cathode material was partially replaced with conductive polymer PEDOT/PSS, which comprised the following steps:

Preparation of electrode plates: Each plate comprised of, in mass percentage, 80% of commercial ternary material as a cathode active material, 4% of chitosan aqueous solution, 2% of SBR aqueous solution and 2% of PEO aqueous solution as binders, and 12% of conducting agent. The mass fraction of PEDOT/PSS in the whole conducting agent (a commercial product of Sigma Aldrich, and mass fraction of the dopant in conductive polymer was 71%) was 10%, and mass ratio of CTS and PEDODPSS was 1:03. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.8˜4.3V under 100˜2000 mAh/g.

Test results: As shown in FIG. 24, the ternary cathode with carboxylated chitosan as the binder wherein 10% of acetylene black was replaced with PEDOT/PSS could maintain a good cycling performance.

### Embodiment 15

The acetylene black in a chitosan aqueous binder for ternary cathode material was partially replaced with conductive polymer PEDOT/PSS, which comprised the following steps:

Preparation of electrode plates: Each plate comprised of, in mass percentage, 80% of commercial ternary material as a cathode active material, 4% of chitosan aqueous solution and 4% of PEO aqueous solution as binders, and 12% of conducting agent. The mass fraction of PEDOT/PSS in the whole conducting agent (a commercial product of Sigma Aldrich, and mass fraction of the dopant in conductive polymer was 71%) was 10%, and mass ratio of CTS and PEDOT/PSS was 1:0.3. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.8˜4.3V under 100˜2000 mAh/g.

Test results: As shown in FIG. 25 the ternary cathode with chitosan as the binder wherein 10% of acetylene black was replaced with PEDOT/PSS had a significantly reduced impedance of 50 Ω/cm² compared with a 150 Ω/cm² impedance of that without PEDOT/PSS which can improve the rate performance of battery.

### FIELD OF THE INVENTION

The present invention relates to the field of energy storage devices such as lithium ion batteries or supercapacitors, specifically to an aqueous composite binder of natural polymer derivative-conducting polymer and application thereof.

### BACKGROUND OF THE INVENTION

In view of the depletion of fossil fuels and the climatic deterioration, developing novel clean energy and implement of energy saving and emissions reduction have become one of the strategic directions all over the world. As the penetration of hybrid vehicles, all-electric vehicles and grid connected power plant of new energy (solar energy, wind energy) makes the high performance power (energy storage) battery one of the valued core technologies, lithium ion battery becomes the most competitive power solution for its advantages such as high voltage, high capacity, good cycling performance and low pollution; supercapacitor has also attracted enough attention in the field of novel energy storage devices, for its extremely high power density. Researches on the lithium ion battery and supercapacitor mainly focus on the active materials, electrolytes, and separators, but rarely on auxiliary materials such as conducting agents and binders. Although conducting agents and binders are used only when they are mixed with active materials or in a coating step, they are indispensible components of energy storage devices, and have a great influence to the performance of the devices.

As lithium ion and electron are both involved in the charging and discharging cycle of lithium ion battery, the electrode thereof shall be made of a material that is a good mixed conductor of both ion and electron, for higher charging and discharging current and longer cyclic life. However, commercial materials for cathode and anode are typically semiconducting, with an electronic conductivity of 10⁻¹˜10⁻⁹ S/cm, which doesn't meet the requirement for the transfer of electrons in the active materials, and thus an introduction of conducting agents into the active materials is necessary to improve the conductivity. At present, most of the commercial conducting agents >are carbon-based materials, such as acetylene black, carbon black, graphite, carbon nanofiber, carbon nanotube and graphene.

Binders are polymers that are used to attach the active materials to the current collector. At present, polyvinylidene fluoride is generally used in industry as a binder, with N-methyl pyrrolidone as the dispersant. Such binder with fluoride swells in electrolyte solution, which results in the decline in the adhesion; they can react with lithium to form lithium carbide, which has an influence on the life and safety of the battery; plus, they are expensive, the solvent thereof has a relative high volatilization temperature, and volatilization of the solvent will cause environmental pollution. In view of the problems, water soluble binders are gradually replacing the oil soluble binders like poly vinylidene fluoride, and become the latest commercial binders for lithium ion battery. Traditional water soluble binders include carboxymethyl cellulose (CMC), polyacrylic acid (PAA), LA132, etc. The application of alginate salts, which have higher hydroxyl content and higher cohesive strength, as binders for silicon anode materials, has been reported (Science, 7, 75-79, 2011). We have recently developed a novel water soluble binder based on chitosan and its derivatives for lithium ion battery, which exhibits good cycling stability and rate performance (Chinese patent application 201210243617). It has also been reported that, a conductive coating film consisting of conductive carbon materials and polybasic acids with hydroxyalkyl chitosan as the resin binder, was formed on a current collector to enhance the adhesion between the collector and the electrode layer, decrease the internal resistance, and also improve the cyclic characteristics (Chinese patent application 201080038127.2). This technology can achieve the desire object, but will also increase the time and cost of the production of electrodes.

Most of the commercial conductive carbon materials are nano scale or micron scale powder materials. They exhibit a bad wettability and an agglomeration tendency when applied in the aqueous binders, which probably results in an agglomeration of the particles in the dried film that affects the electronic conductivity of the electrodes, and thereby the performance of the lithium ion batteries drops so that they cannot meet the requirement.

Poly(3,4-ethylenedioxythiophene) (PEDOT), polypyrrole (PPy) and polyaniline (PAN), when they are doped, have high electronic conductivity, and have high structural and conductive stability in air. Thus, these conductive polymers have become a hot topic, and are typically used to form composites or coatings for electrode of lithium ion batteries. For example, composite electrode materials were prepared by hydrothermal synthesis from LiFePO₄ and poly(3,4-ethylenedioxythiophene) (Electroanalysis, 23, 2079-2086, 2011), and by electrochemical synthesis from LiFePO₄ and polypyrrole (J. Power Sources, 195, 5351-5359, 2010). The application of polyaniline as a binder for lithium titanium oxide, graphite and silicon/graphite composite materials has also been reported (Electrochemistry Communications 29, 45-47, 2013). Furthermore, while use of conductive binders, which are prepared by chemical synthesis from conductive polymers (such as PAN) and ionic polymers (such as PEO and PAA), for lithium ion batteries or supercapacitors, can also significantly enhance the electrochemical performance thereof, most of the ionic polymers are prepared by chemical synthesis (Chinese patent application 200610136939.6) which is high-cost and highly polluting.

### SUMMARY OF THE INVENTION

It is one object of the present invention to provide an aqueous composite binder of natural polymer derivative-conducting polymer, and an application thereof in electrochemical energy storage devices.

In aqueous binder system, commercial carbon-based conducting agents are difficult to disperse due to their low wettability, and have low compaction density. In view of the above disadvantages, conductive polymers used in aqueous binder system as conductive additives for electrodes of lithium ion batteries and can fully or partially replace the commercial conducting agents such as acetylene black are provided. They can increase the compaction density and electric conductivity of the electrodes, and thereby the discharge capacity of the electrode materials and the cycling stability and rate performance of the batteries are enhanced. When doped with the anion of polystyrene sulfonic acid (PSS) or p-toluenesulfonic acid, the conductive polymers PEDOT, PPy and PAIN can be dispersed homogeneously in aqueous solution, and have, high stability high electric conductivity and good film-forming property. Thus, doped conductive polymers (PEDOT, PPy and PAN) can filly or partially replace the commercial conducting agents such as acetylene black, and can be used in aqueous binder system as conductive additives for electrodes of lithium ion batteries to improve the electrical conductivity of the electrode materials, and somewhat overcome the disadvantages of the commercial carbon-based conducting agents such as difficulty to disperse and agglomeration tendency in aqueous binder system due to their low wettability. Also, they can form a conductive film with certain ductility on the surface of the active materials to somehow suppress the volume change of some active materials during charging and discharging. Introduction of the conductive polymers can reduce the content of commercial conducting agents such as acetylene black in electrodes to increase the compaction density of the electrodes and the volumetric specific capacity of the batteries. Moreover, they can be spread out evenly when coated on electrodes and improve the interfacial property between the electrode and the electrolyte, so as to improve the coulombic efficiency of the electrode materials, and cycling stability and rate performance of the batteries.

The aqueous composite binder of natural polymer derivative-conducting polymer contains water soluble natural polymer derivative and water soluble conductive polymer, wherein a weight ratio of the water soluble natural polymer derivative to the water soluble conductive polymer is 1:3.75˜1:0.038, and said water soluble conductive polymer contains a dopant with a mass fraction of 67%˜71%.

The conductive polymer aqueous composite binder can be mixed with active materials and commercial conducting agents in water to form a paste that is used in the preparation of electrodes of lithium ion batteries, capacitors or other energy storage systems. The water soluble natural polymer derivative is used to increase the cohesive strength between the electrode active materials and the current collectors; the conductive polymer is water soluble, and is used to provide a homogeneous conductive connection for the active materials. The conductive polymer can partially or fully replace the commercial conducting agents such as acetylene black, and improve the electrochemical performance of batteries by reducing the internal resistance of the electrodes and increasing the compaction density thereof.

Said water soluble binder is at least one of the natural polymer derivatives (chitosan derivative, carboxymethyl cellulose or alginate).

Said conductive polymer is that tends to be dispersed in aqueous solution or organic solution, and preferably poly(3,4-ethylenedioxythiophene), polyaniline or polypyrrole. The dopant in the conductive polymer is a poly(styrenesulfonate) salt or a p-toluenesulfonate salt. The doped conductive polymer can fully or partially replace the commercial conducting agents in aqueous binder system, wherein said commercial conducting agents are acetylene black, carbon black, ketjen black, natural graphite, synthetic graphite, carbon nanofiber, carbon nanotube and graphene. The mass faction of the conductive polymer in the conducting agent is 1%˜100%.

The binder of the present invention can be combined with dispersion medium, which is an aqueous solution of a dispersant such as polystyrene sulfonic acid (PSS). The mass fraction of said conductive polymer (PEDOT, PAN or PPy) in the dispersion medium is 1:100˜1:10; the solid content of the PEDOT:PSS solution is 1%˜3%, the solid content of the PAN:PSS solution is 1%˜10%, and the solid content of the PPy:PSS solution is 1%˜10%.

The present invention can be applied to at least one of the following active materials: lithium iron phosphate, lithium cobalt oxide, lithium manganese oxide, nickel-cobalt-manganese ternary material, lithium nickel manganese oxide, lithium nickel phosphate, lithium cobalt phosphate, lithium manganese phosphate, lithium-rich solid solution cathode material, graphite, lithium titanium oxide, metal oxide anode material, tin-based composite anode material and silicon-based composite anode material.

Use of the aqueous composite binder of natural polymer derivative-conducting polymer as electrode conducting material and binder material of electrochemical energy storage devices is also provided, which is capable of fully or partially replacing the commercial conducting agent, and can be applied in the production of lithium for batteries, capacitors or other energy storage systems. The conductive polymer aqueous composite binder can be used to produce an electrode plate for energy storage devices, electrode material of which contains the aforementioned aqueous composite binder of natural polymer derivative-conducting polymer. According to another aspect of the invention, an energy storage device having the aforementioned electrode plate includes but is not limited to lithium ion battery and supercapacitor.

Compared with the prior art, the present invention provides the following advantages:

(1) The water soluble polymer derivatives used therein is natural, low-cost and pollution-free, and can be obtained widely.

(2) Doped conductive polymers (PEDOT, PPy or PAN) are used as conducting agent in aqueous binder system. These polymers can be dispersed homogeneously in aqueous solution, have high stability, and can form a film with high electrical conductivity over the surface of active materials so as to improve the electrical conductivity of the materials. Meanwhile, the film has good ductility so that it can somehow suppress the volume change of some active materials (for example, silicon-based anode material) during charging and discharging, so as to improve the rate performance of the batteries and increase the life thereof.

(3) Commercial carbon-based conductive materials tend to agglomerate and are difficult to be dispersed in aqueous system due to their low wettability. This disadvantage is somehow overcome by partially replacing them with doped conductive polymers (PEDOT, PPy or PAN).

(4) The content of commercial conducting agents such as acetylene black in the electrode is reduced by introduction of the conductive polymer, resulting in that, the compaction density of the electrodes and the volumetric specific capacity of the batteries increase, and internal resistance of the electrodes is reduced such that the rate performance of the batteries is enhanced.

(5) The binder of the present invention can be spread out evenly when coated on electrode and improve the interfacial property between electrode and electrolyte, so as to improve coulombic efficiency of the electrode materials and cycling stability and rate performance of the batteries.

(6) The water soluble natural polymer derivative binder containing conductive polymer of the present invention can be applied to both anode materials and cathode materials.

(7) The present invention is environmental friendly, easy to implement with its simple and reproducible preparation, widely applicable, and thus provides a research direction for high capacity lithium ion batteries.

### BRIEF DESCRIPTION OF THE DRAWINGS

FIG. 1 shows SEM images of the conducting agents used in embodiment 1 and silicon (elementary substance) electrode plates made thereof, wherein: (a) SEM image of acetylene black, (b) SEM image of PEDOT/PSS (c) SEM image (at low magnification) of a electrode plate without PEDOT/PSS, (d) SEM image (at high magnification) of a electrode plate without PEDOT/PSS, (e) SEM image (at low magnification) of a electrode plate with PEDOT/PSS, (f) SEM image (at high magnification) of a electrode plate with PEDOT/PSS, (g) SEM image of a electrode plate without PEDOT/PSS, having been subject to 100 cycles, and (h) SEM image of a electrode plate with PEDOT/PSS, having been subject to 100 cycles.

FIG. 2 shows the AC impedance curves of silicon (elementary substance) electrode plates with different amount of PEDOT/PSS in embodiment 1.

FIG. 3 shows the charge/discharge curves of the first cycle of silicon (elementary substance) electrode plates with different amount of PEDOT/PSS in embodiment 1, at 0.01˜1.50V under 200 mA/g.

FIG. 4 shows the cyclic voltammograms of the first three cycles of silicon (elementary substance) electrode plates with 50% (mass fraction) of PEDOT/PSS in the whole conducting agent and without PEDOT/PSS in embodiment 1, at a scan rate of 0.2 mV/s.

FIG. 5 shows the electrochemical cycling curves of silicon (elementary substance) electrode plates with different amount of PEDOT/PSS in embodiment 0.01˜1.50V under 200 mA/g.

FIG. 6 shows the electrochemical rate cycling curves of silicon (elementary substance) electrode plate with 50% (mass fraction) of PEDOT/PSS in the whole conducting agent in embodiment 1, at 0.01˜1.50V wider 200˜10000 mA/g.

FIG. 7 shows the charge/discharge curves of the first cycle of silicon (elementary substance) electrode plate in embodiment 2 with 33% (mass fraction) of PEDOT/PSS in the whole conducting agent, carboxymethyl chitosan as the binder, at 0.01˜1.50V under 200 mA/g.

FIG. 8 shows the charge/discharge curves of the first cycle of silicon (elementary substance) electrode plates with different amount of PAN/PSS in embodiment 3, at 0.01˜1.50V under 200 mA/g.

FIG. 9 shows the electrochemical cycling curves of silicon (elementary substance) electrode plates with different amount of PAN/PSS in embodiment 3, at 0.01˜1.50V under 200 mA/g.

FIG. 10 shows the AC impedance curves of silicon (elementary substance) electrode plates with different amount of PAN/PSS in embodiment 3.

FIG. 11 shows the charge/discharge curves of the first cycle of silicon (elementary substance) electrode plate with 50% (mass fraction) of PPy/PSS and without PPy/PSS in embodiment 4, at 0.01˜1.50V under 200 mA/g.

FIG. 12 shows the electrochemical cycling curves of silicon (elementary substance) electrode plates with 50% (mass fraction) of PPy/PSS and without PPy/PSS in embodiment 4, at 0.01˜1.50V under 200 mA/g.

FIG. 13 shows the electrochemical cycling curves of graphite electrode plates with 50% (mass fraction) of PEDOT/PSS in the whole conducting agent in embodiment 5, at 0.00˜3.0V under 100 mA/g.

FIG. 14 shows the electrochemical rate cycling curves of graphite electrode plate with 50% (mass fraction) of PEDOT/PSS in the whole conducting agent in embodiment 5, at 0.00˜3.0V under 100˜2000 mA/g.

FIG. 15 shows the AC impedance curves of graphite electrode plate in embodiment 6 with 33% (mass fraction) of PEDOT/PSS in the whole conducting agent, carboxymethyl chitosan as the binder.

FIG. 16 shows the electrochemical cycling curves of lithium titanium oxide electrode plates in embodiment 7 with 50% (mass fraction) of PEDOT/PSS and without PEDOT/PSS, CMC as the binder, at 1.0˜15V under 0.5˜5C.

FIG. 17 shows the electrochemical rate curves of lithium titanium oxide electrode plates in embodiment 7 with 50% (mass fraction) of PEDOT/PSS and without PEDOT/PSS, CMC as the binder, at 1.0˜2.5V under 0.5˜5C.

FIG. 18 shows the cycling curves of LFP cathode material in embodiment 8 wherein 50% of acetylene black is replaced with conductive polymer PEDOT/PSS, in a water soluble chitosan binder.

FIG. 19 shows the cycling curves of LFP cathode material in embodiment 9 wherein 30% of acetylene black is replaced with conductive polymer PEDOT/PSS, in a water soluble chitosan binder.

FIG. 20 shows the AC impedance curves of LFP cathode material in embodiment 9 wherein 30% of acetylene black is replaced with conductive polymer PEDOT/PSS, in a water soluble chitosan binder.

FIG. 21 shows the cycling curves of LFP cathode material in embodiment 10 wherein 1% of acetylene black is replaced with conductive polymer PEDOT/PSS, in a water soluble chitosan binder.

FIG. 22 shows the cycling curves of LFP cathode material in embodiment 11 wherein 100% of acetylene black is replaced with conductive polymer PEDOT/PSS, in a water soluble chitosan binder.

FIG. 23 shows the cycling curves of LFP cathode material in embodiment 13 wherein 10% of acetylene black is replaced with conductive polymer PEDOT/PSS, ire a water soluble sodium alginate binder.

FIG. 24 shows the cycling curves of ternary cathode material in embodiment 14 wherein 10% of acetylene black is replaced with conductive polymer PEDOT/PSS, in a water soluble chitosan binder (4% of chitosan aqueous solution, 2% of SBR aqueous solution and 2% of PEO aqueous solution as the binder).

FIG. 25 shows the AC impedance curves of LCO cathode material in embodiment 15 wherein 10% of acetylene black is replaced with conductive polymer PEDOT/PSS, in a water soluble chitosan binder.

### DETAILED DESCRIPTION OF THE EMBODIMENTS

Further characteristics and advantages of the present invention will be more readily apparent from the detailed description of the following embodiments.

### Embodiment 1

Acetylene black was partially replaced with conductive polymer PEDOT/PSS in a CMC aqueous binder for silicon-based anode material, which comprised the following steps:

Preparation of electrode plates: Each plate comprised of, in mass percentage, 70% of silicon (elementary substance) powder as an anode active material, 10% of CMC aqueous solution (with a viscosity of 300˜1200 cps) as a binder, and 20% of conducting agent. In different sample, the mass fraction of PEDOT/PSS in the whole conducting agent (a commercial product of Sigma Aldrich, and mass fraction of the dopant in conductive polymer was 71%) was 20%, 33% or 50%, and mass ratio of CMC and PEDOT/PSS was 1:0.4, 1:0.66 or 1:1. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜4.50V under 200˜10000 mA/g.

Test results: As shown in FIGS. 1a and 1b, acetylene black was in the form of particles of about 50 nm, while PEDOT/PSS was in the form of sheets or membranes. As shown in FIGS. 1c and 1e, uniformity of the silicon-based anode plate was improved when the acetylene black therein was replaced with the conductive polymer PEDOT/PSS. As shown in FIGS. 1d and 1f, the conductive polymer PEDOT/PSS had formed a compact conductive film over the surface of the active material. As shown in FIGS. 1g and 1h, the conductive polymer PEDOT/PSS had formed a compact conductive film over the surface of the active material.

As shown in FIG. 2, introduction of the conductive polymer can effectively reduce the charge transfer impedance of the electrode material. As shown in FIG. 3, under 200 mA/g, the silicon (elementary substance) material with only acetylene black showed a first specific discharge capacity of 3422 mAh/g and a first coulombic efficiency of 66%, while that in which acetylene black was partially replaced with PEDOT/PSS showed a first specific discharge capacity of 3954˜4163 mAh/g and a first coulombic efficiency of 81˜85%. Plus, introduction of PEDOT/PSS had efficiently reduced the voltage difference of the charge/discharge plateau, indicating that the polarization of the electrode during charging/discharging was reduced. The voltammograms (as shown in FIG. 4) of the first three cycles of the electrodes also indicated that introduction of PEDOT/PSS significantly reduced the polarization of the electrode in the first three cycles. The specific discharge capacity of the silicon (elementary substance) electrode with 50% (mass fraction) of PEDOT/PSS in the whole conducting agent after 27 cycles was around 3000, much higher that that with only acetylene black (as shown in FIG. 5), and maintained a specific discharge capacity of 2440 mAh/g under 600 mA/g after cycling under a sequence of current density ranged from 200˜10000 mA/g with 5 cycles each (as shown in FIG. 6).

### Embodiment 2

Acetylene black was partially replaced with conductive polymer PEDOT/PSS in a carboxymethyl chitosan aqueous binder for silicon-based anode material, which comprised the following steps:

Preparation of electrode plates: Each plate comprised of, in mass percentage, 70% of silicon (elementary substance) powder as an anode active material, 10% of carboxymethyl chitosan aqueous solution (with a viscosity of 100˜200 cps) as a binder, and 20% of conducting agent. The mass fraction of PEDOT/PSS in the whole conducting agent (a commercial product of Sigma Aldrich, and mass fraction of the dopant in conductive polymer was 71%) was 33%, and mass ratio of carboxymethyl chitosan and PEDOT/PSS was 1:0.66. The above components were mixed, with water as the solvent, to obtain an anode paste with a viscosity of 2000-4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200˜10000 mA/g.

Test results: As shown in FIG. 7, when using carboxymethyl chitosan aqueous solution as the binder, the silicon (elementary substance) material with only acetylene black as the conducting agent showed a first specific discharge capacity of 3658mAh/g; when the content of PEDOT/PSS in the whole conducting agent was 33% (mass fraction), it showed a first specific discharge capacity of 3750 mAh/g, and the cycling stability of the battery increased significantly.

### Embodiment 3

Acetylene black was partially replaced with conductive polymer PAN/PSS in a CMC aqueous binder for silicon-based anode material, which comprised the following steps:

Preparation of electrode plates: Each plate comprised of, in mass percentage, 70% of silicon (elementary substance) powder as an anode active material, 10% of CMC aqueous solution (with a viscosity of 300˜1200 cps) as a binder, and 20% of conducting agent. In different sample, the mass fraction of PAN/PSS in the whole conducting agent (a commercial product of Sigma Aldrich, and mass fraction of the dopant in conductive polymer was 67%) was 20%, 33% or 50%, and mass ratio of CMC and PAN/PSS was 1:0.4, 1:0.66 or 1:1. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate. The PAN/PSS aqueous solution was prepared in the laboratory with a solid content of 2.14% (with reference to J. Mater Sci. 41(2006), 7604-7610), wherein the organic solution of PAN was a commercial product of Aldrich (a toluene solution with a solid content of 2˜3%).

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200 mA/g.

Test results: As shown in FIG. 8, under 200 mA/g, the silicon (elementary substance) material with only acetylene black showed a first specific discharge capacity of 3422 mAh/g and a first coulombic efficiency of 66%, while that in which acetylene black was partially replaced with PAN/PSS showed a first specific discharge capacity of 3855˜4533 mAh/g and a first coulombic efficiency of 84˜90%. Plus, introduction of PAN/PSS had efficiently reduced the voltage difference of the charge/discharge plateau, indicating that the polarization of the electrode during charging/discharging was reduced. The specific discharge capacity of the silicon (elementary substance) electrode with 33% (mass fraction) of PAN/PSS in the whole conducting agent after 25 cycles was around 2500, much higher that that with only acetylene black (as shown in FIG. 9). As shown in FIG. 10, introduction of the conductive polymer PAN can effectively reduce the charge transfer impedance of the electrode material.

### Embodiment 4

Acetylene black was partially replaced with conductive polymer PPy/PSS in a CMC aqueous binder for silicon-based anode material, which comprised the following steps:

Preparation of electrode plates: Each plate comprised of, in mass percentage, 70% of silicon (elementary substance) powder as an anode active material, 10% of CMC aqueous solution (with a viscosity of 300˜1200 cps) as a binder, and 20% of conducting agent. The mass fraction of PPy/PSS in the whole conducting agent (a commercial product of Sigma Aldrich, and mass fraction of the dopant in conductive polymer was 67%) was 50%, and mass ratio of CMC and PPy/PSS was 1:1. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate. The PPy/PSS aqueous solution was prepared in the laboratory with a solid content of 2.06% (with reference to J. Mater Sci. 41(2006), 7604-7610).

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.01˜1.50V under 200 mA/g.

Test results: As shown in FIG. 11, under 200 mA/g, the silicon (elementary substance) material with only acetylene black showed a first specific discharge capacity of 3422 mAh/g and a first coulombic efficiency of 66%, while that in which acetylene black was partially replaced with PPy/PSS showed a first specific discharge capacity of 3775 mAh/g and a first coulombic efficiency of 75%. Plus, introduction of PPy/PSS had efficiently reduced the voltage difference of the charge/discharge plateau, indicating that the polarization of the electrode during charging/discharging was reduced. The specific discharge capacity of the silicon (elementary substance) electrode with 50% (mass fraction) of PPy/PSS in the whole conducting agent after 25 cycles was around 953 mA/h (as shown in FIG. 12).

### Embodiment 5

Acetylene black was partially replaced with conductive polymer PEDOT/PSS in a CMC aqueous binder for graphite anode material, which comprised the following steps:

Preparation of electrode plates: Each plate comprised of, in mass percentage, 80% of commercial graphite as an anode active material, 10% of CMC aqueous solution (with a viscosity of 300˜1200 cps) as a binder, and 10% of conducting agent. The mass fraction of PEDOT/PSS in the whole conducting agent (a commercial product of Sigma Aldrich, and mass fraction of the dopant in conductive polymer was 71%) was 50%, and mass ratio of carboxymethyl chitosan and PEDOT/PSS was 1:0.5. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.0˜3.0V under 100˜2000 mA/g.

Test results: As shown in FIG. 13, the graphite electrode with 50% (mass fraction) of PEDOT/PSS in the whole conducting agent showed a first specific discharge capacity of 509 mAh/g and a first coulombic efficiency of 82%, and maintained a specific, discharge capacity of around 413 mAh/g after 100 cycles, which is much higher than the theoretical value of graphite. It maintained a specific discharge capacity of 405 mAh/g under 100 mA/g after cycling under a sequence of current density ranged from 100˜2000 mA/g with 10 cycles each (as shown in FIG. 14).

### Embodiment 6

Acetylene black was partially replaced with conductive polymer PEDOT/PSS in a carboxymethyl chitosan (CTS) aqueous binder for graphite anode material, which comprised the following steps:

Preparation of electrode plates: Each plate comprised of, in mass percentage, 80% of commercial graphite as an anode active material, 10% of CTS aqueous solution (with a viscosity of 100˜200 cps) as a binder, and 10% of conducting agent The mass fraction of PEDOT/PSS in the whole conducting agent (a commercial product of Sigma Aldrich, and mass fraction of the dopant in conductive polymer was 71%) was 33%, and mass ratio of CTS and PEDOT/PSS was 1:03. The above components were mixed, with water as the solvent, to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.0˜3.0V under 100˜2000 mA/g.

Test results: As shown in FIG. 15, the impedance of the battery was reduced from 60 Ω/cm² (without PEDOT/PSS) to 30 Ω/cm² (with 33% (mass fraction) of PEDOT/PSS in the whole conducting agent).

### Embodiment 7

Acetylene black was partially replaced with conductive polymer PEDOT/PSS in a CMC aqueous binder for lithium titanium oxide anode material, which comprised the following steps:

Preparation of electrode plates: Each plate comprised of, in mass percentage, 80% of lithium titanium oxide as an anode active material, 10% of CMC aqueous solution (with a viscosity of 300˜1200 cps) as a binder, and 10% of conducting agent. The mass fraction of PEDOT/PSS in the whole conducting agent (a commercial product of Sigma Aldrich, and mass fraction of the dopant in conductive polymer was 71%) was 50%, and mass ratio of CMC and PEDOT/PSS was 1:0.5. The above components were mixed, with water as the solvent., to obtain an anode paste with a viscosity of 2000˜4000 cps. The anode paste was coated on a 20 μm thick copper foil that was used as a current collector by a coating machine, and dried in a vacuum oven at 60° C. to form a electrode plate which was then sheared by a punching machine to obtain an anode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 0.5˜3.0V and 0.2˜50 C.

Test result: As shown in FIG. 16, at a rate of 0.5 C, while the lithium titanium oxide anode with acetylene black only as conducting agent showed a first specific discharge capacity of 171 mAh/g, and maintained a specific discharge capacity of around 156 mAh/g after 100 cycles, the lithium titanium oxide anode with 50% (mass fraction) of PEDOT/PSS in the whole conducting agent showed a first specific discharge capacity of 187 mAh/g and a first coulombic efficiency of 98%, and maintained a specific discharge capacity of around 171 mAh/g after 100 cycles, which is close to the theoretical value of lithium titanium oxide. At a rate of 0.2 C, it maintained a specific discharge capacity of 173 mAh/g after cycling from 0.2 to 0.5 C, and 161 mAh/g after cycling from 0.2˜50 C (as shown in FIG. 17).

### Embodiment 8

50% of acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 50%, and mass ratio of CTS and PEDOT/PSS was 1:1.88. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 18, at 0.1 C, the LFP electrode wherein 50% of the commercial conducting agent was replaced with PEDOT/PSS showed a first specific discharge capacity of 144 mAh/g and a first coulombic efficiency of 91.74%. The specific discharge capacity increased from the second cycle on, and remained at around 154 mAh/g after 100 cycles, indicating a capacity retention close to 100%.

### Embodiment 9

30% of acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 30%, and mass ratio of CTS and PEDOT/PSS was 1:1.13. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 19, capacity of the commercial LFP electrode wherein 30% of acetylene black, was, replaced with PEDOT/PSS increased significantly during the first few cycles, and reached and stabilized at about 150 mAh/g, which remained at 152 mA/h after 100 cycles. As shown in FIG. 20, the impedance of the battery was reduced from 60 Ω/cm² (without PEDOT/PSS) to 15 Ω/cm² (with PEDOT/PSS).

### Embodiment 10

1% of acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 1%, and mass ratio of CTS-based binder and PEDOT/PSS was 1:0.038. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 21, the commercial LFP electrode wherein 1% of acetylene black was replaced with PEDOT/PSS had a first specific discharge capacity of 145 mAh/g at 0.1 C. The specific discharge capacity thereof increased during the first few cycles, and maintained at about 153 mAh/g after 100 cycles, indicating a capacity retention close to 100%.

### Embodiment 11

All the acetylene black in a chitosan aqueous binder for LFP cathode material was replaced with conductive polymer PEDOT/PSS, which comprised the following steps:

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 100%, and mass ratio of CTS and PEDOT/PSS was 1:3.75. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC DEC and DMC (1:1:1 in volume ratio) as electrolyte solution. A galvanostatic charge and discharge test on the batteries was performed at 2.5˜4.0V under 100˜2000 mAh/g.

Test results: As shown in FIG. 22, the commercial LFP electrode wherein all the acetylene black was replaced with PEDOT/PSS had a first specific discharge capacity of 138 mAh/g at 0.1 C. The specific discharge capacity thereof increased from the second cycle on, and reached and maintained at about 147.6 mAh/g after 100 cycles.

### Embodiment 12

Determination of the compaction density of LFP cathode material, wherein all the acetylene black in a chitosan aqueous binder for LFP cathode material was replaced with conductive polymer PEDOT/PSS.

Preparation of electrode plates: Each plate comprised of, in mass percentage, 90% of commercial LFP as a cathode active material, 1.6% of chitosan aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 100%, and mass ratio of CTS and PEDOT/PSS was 1:3.75. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate with a certain surface density.

With regard to design of lithium ion battery, compaction density=surface density/thickness of the material=surface density/(thickness of the rolled plate thickness of the current collector), and the unit of compaction density is g/cm³. The above-mentioned plate with a blown surface density was rolled under a certain pressure to a certain thickness which was then measured to calculate the compact density. Under laboratory condition, the compact density of the plate without PEDOT/PSS is 1.4 g/cm³, while that with PEDOT/PSS is 1.7 g/cm³, indicating that introduction of PEDOT/PSS can significantly increase the compaction density of electrode plate.

### Embodiment 13

The acetylene black in a sodium alginate aqueous binder for LFP cathode material was partially replaced with conductive polymer PEDOT/PSS, which comprised the following steps:

Preparation of electrode plates: Each plate comprised of, in mass percentage, 90% of commercial LFP as a cathode active material, 1.6% of sodium alginate aqueous solution and 2.4% of SBR aqueous solution as a binder, and 6% of conducting agent. The mass fraction of PEDOT/PSS in the whole conducting agent (a commercial product of Sigma Aldrich, and mass fraction of the dopant in conductive polymer was 71%) was 10%, and mass ratio of sodium alginate and PEDOT/PSS was 1:0.375. The above components were mixed, with water as the solvent, to obtain a cathode paste with a viscosity of 2000˜4000 cps The cathode paste was coated on a 20 μm thick aluminium foil that was used as a current collector by a coating machine, and dried in a vacuum over at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 3.0˜4.2V under 100˜2000 mAh/g.

Test results: As shown in FIG. 23, LFP cathode material with sodium alginate as the binder wherein 10% of acetylene black was replaced with PEDOT/PSS could maintain a good cycling performance and high specific capacity.

### Embodiment 14

The acetylene black in a carboxylated chitosan aqueous binder for ternary cathode material was partially replaced with conductive polymer PEDOT/PSS, which comprised the following steps:

Preparation of electrode plates: Each plate comprised of, in mass percentage, 80% of commercial ternary material as a cathode active material, 4% of chitosan aqueous solution, 2% of SBR aqueous solution and 2% of PEO aqueous solution as binders, and 12% of conducting agent. The mass fraction of PEDOT/PSS in the whole conducting agent (a commercial product of Sigma Aldrich, and mass fraction of the dopant in conductive polymer was 71%) was 10%, and mass ratio of CTS and PEDOT/PSS was 1:0.3. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.8˜4.3V under 100˜2000 mAh/g.

Test results: As shown in FIG. 24, the ternary cathode with carboxylated chitosan as the binder wherein 10% of acetylene black was replaced with PEDOT/PSS could maintain a good cycling performance.

### Embodiment 15

The acetylene black in a chitosan aqueous binder for ternary cathode material was partially replaced with conductive polymer PEDOT/PSS, which comprised the following steps:

Preparation of electrode plates: Each plate comprised of, in mass percentage, 80% of commercial ternary material as a cathode active material, 4% of chitosan aqueous solution and 4% of PEO aqueous solution as binders, and 12% of conducting agent. The mass fraction of PEDOT/PSS in the whole conducting agent (a commercial product of Sigma Aldrich, and mass fraction of the dopant in conductive polymer was 71%) was 10%, and mass ratio of CTS and PEDOT/PSS was 1:0.3. The above components were mixed, with water as the solvent, to obtain a cathode paste with a viscosity of 2000˜4000 cps. The cathode paste was coated on a 20 μm thick aluminium foil that was used as a current collector by a coating machine, and dried in a vacuum oven at 110° C. to form a electrode plate which was then sheared by a punching machine to obtain a cathode plate.

Preparation of batteries: Button batteries (CR2025) were prepared with lithium plate as counter electrode, polyethylene membrane as separator, and a mixture of 1M LiPF₆/EC, DEC and DMC (1:1:1 in volume ratio) as electrolyte solution. A galvanostatic charge and discharge test on the batteries was performed at 2.8˜4.3V under 100˜2000 mAh/g.

Test results: As shown in FIG. 25, the ternary cathode with chitosan as the binder wherein 10% of acetylene black was replaced with PEDOT/PSS had a significantly reduced impedance of 50 Ω/cm² compared with a 150 Ω/cm² impedance of that without PEDOT/PSS, which can improve the rate performance of battery.

What is claimed is:

1. An aqueous composite binder of natural polymer derivative-conducting polymer, comprising
water soluble natural polymer derivative and water soluble conductive polymer,
wherein a weight ratio of the water soluble natural polymer derivative to the water soluble conductive polymer is 1:3.75˜1:0.038.

2. The aqueous composite binder of natural polymer derivative-conducting polymer of claim 1, wherein the natural polymer derivative is at least one of the following: chitosan derivative, carboxymethyl cellulose or alginate.

3. The aqueous composite binder of natural polymer derivative-conducting polymer of claim 1 wherein the water soluble conductive polymer contains a dopant with a mass fraction of 67%˜71%; the water soluble conductiNT polymer is poly(3,4-ethylenedioxythiophene), polyaniline or polypyrrole, the dopant is a poly(styrenesulfonate) salt or a p-toluenesulfonate salt.

4. The aqueous composite binder of natural polymer derivative-conducting polymer of claim 1, comprising
fully or partially replacing a commercial conducting agent, which can be applied in a production of lithium ion batteries, capacitors or other energy storage systems,
wherein the aqueous composite binder of natural polymer derivative-conducting polymer contains water soluble natural polymer derivative and water soluble conductive polymer, wherein a weight ratio of the water soluble natural polymer derivative to the water soluble conductive polymer is 1:3.75˜1:0.038.

5. An electrode plate for energy storage device, comprising
electrode material, which contains an aqueous composite binder of natural polymer derivative-conducting polymer, which contains water soluble natural polymer derivative and water soluble conductive polymer,
wherein a weight ratio of the water soluble natural polymer derivative to the water soluble conductive polymer is 1:3.75˜1:0.038.

6. An energy storage device having electrode plate, comprising
electrode material, which contains an aqueous composite binder of natural polymer derivative-conducting polymer, which contains water soluble natural polymer derivative and water soluble conductive polymer,
wherein a weight ratio of the water soluble natural polymer derivative to the water soluble conductive polymer is 1:3.75˜1:0.038.

7. The electrode plate for energy storage device of claim 5, wherein the natural polymer derivative is at least one of the following: chitosan derivative, carboxymethyl cellulose or alginate.

8. The electrode plate for energy storage device of claim 5, wherein the water soluble conductive polymer contains a dopant with a mass fraction of 67%˜71%; the water soluble conductive polymer is poly(3,4-ethylenedioxythiophene), polyaniline or polypyrrole, the dopant is a poly(styrenesulfonate) salt or a p-toluenesulfonate salt.

9. The energy storage device having the electrode plate of claim 6, wherein the natural polymer derivative is at least one of the following: chitosan derivative, carboxymethyl cellulose or alginate.

10. The energy storage device having the electrode plate of claim 6, wherein the water soluble conductive polymer contains a dopant with a mass fraction of 67%˜71%; the water soluble conductive polymer is poly(3,4-ethylenedioxythiophene), polyaniline or polypyrrole, the dopant is a poly(styrenesulfonate) salt or a p-toluenesulfonate salt.
